(19) United States
(12) Patent Application Publication
(10) Pub. No.: US 2018/0306180 A1
(43) Pub. Date: Oct. 25, 2018

(54) DOWNWARD LIQUID PUMP

(71) Applicants: LIVING FOUNTAIN PLASTIC INDUSTRIAL CO., LTD., Taichung City (TW); VIMMAX INDUSTRIAL CO., LTD., Taipei city (TW)

(72) Inventors: Ching-Chung CHAN, Taichung City (TW); Chun-Hsiang CHENG, Taichung City (TW); Kuan-Pang LIN, Taipei City (TW); Che-Wei YU, Taipei City (TW)

(21) Appl. No.: 15/724,871

(22) Filed: Oct. 4, 2017

Related U.S. Application Data
(60) Provisional application No. 62/488,024, filed on Apr. 20, 2017.

(51) Int. Cl. F04B 49/22; F04B 9/14; F04B 9/06; F04B 23/02; F04B 19/22; B05B 11/00

(52) U.S. Cl. CPC F04B 49/22; F04B 9/14; F04B 9/06; F04B 23/025; F04B 53/143; B05B 11/0059; B05B 11/3001; B05B 11/3047; B05B 11/3074; F04B 19/22

(57) ABSTRACT

A motor system includes at least two motors respectively having an output power and a rotary shaft, wherein at least one coupling is provided to connected the at least two rotary shafts. A detect unit is electrically connected to each of the at least two motors and detects the currents of the at least two motors and forms detecting signals relative to the current value of each of the at least two motors. A control unit is electrically connected to the at least two motors for receiving a controlling signal and the detecting signal for adjusting an output power to the electric actuator.

### CROSS-REFERENCE TO RELATED U.S. APPLICATIONS

This application claims priority to U.S. Provisional Application No. 62/488024, filed Apr. 20, 2017, presently pending.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

REFERENCE TO AN APPENDIX SUBMITTED ON COMPACT DISC

Not applicable.

### BACKGROUND OF THE INVENTION

### 1. Field of the Invention

The present invention relates generally to a pump; and more particularly to the disclosure of an innovative downward liquid pump structure type.

### 2. Description of Related Art Including Information Disclosed Under 37 CFR 1.97 and 37 CFR 1.98.

The pump is a discharge control structure extensively used in emulsion product structures for pumping out the emulsion from the container by pressing.

The known emulsion pump structure type is fixed to the orifice at the top of container. The pump comprises a suction pipe base in the container and a press head exposed on the container orifice. The press head is connected to an emulsion delivery pipe. In terms of the use of the known emulsion pump, the user presses the press head downward by hand, and the press head can be restored upward, driving a piston component connected to the bottom of the press head to travel up and down in a cylinder chamber located in the suction pipe base, with a check valve located in the cylinder chamber, the emulsion in the container can be delivered through the emulsion delivery pipe successively with the vertical motion of the press head and piston component.

Thus, to overcome said problems of the prior art, it would be an advancement in the art to provide an improved structure that can significantly improve the efficacy.

Therefore, the inventor has provided the present invention of practicability after deliberate design and evaluation based on years of experience in the production, development and design of related products.

### BRIEF SUMMARY OF THE INVENTION

A circlet, discharge actuating unit, discharge end, elastic restoring component, housing, air chamber and air inlet form the innovative unique structure type and technical characteristics of the “downward liquid pump” disclosed in the present invention. In comparison to the known structures proposed by previous techniques, the present invention provides an innovative downward liquid pump to be fixed to the orifice in the lower end of the inverted container. It is convenient for cleaning and can keep the air pressure in the inverted container in normal state.

### BRIEF DESCRIPTION OF THE SEVERAL VIEWS OF THE DRAWINGS

FIG. 1 is the combined stereogram of the preferred embodiment of the present invention.

FIG. 2 is the exploded view of the preferred embodiment of the present invention.

FIG. 3 is the three-dimensional enlarged view of the check valve in the preferred embodiment of the present invention.

FIG. 4 is the three-dimensional enlarged view of local structure of piston in the preferred embodiment of the present invention.

FIG. 5 is the combined sectional view I of the preferred embodiment of the present invention, downward displacement of head end of the piston.

FIG. 6 is the close-up view of FIG. 5.

FIG. 7 is the combined sectional view II of the preferred embodiment of the present invention, upward displacement of head end of the piston.

FIG. 8 is the close-up view of FIG. 7.

FIG. 9 is the embodiment of air pressure connecting passage in the upper end of air chamber formed of check valve in the present invention.

### DETAILED DESCRIPTION OF THE INVENTION

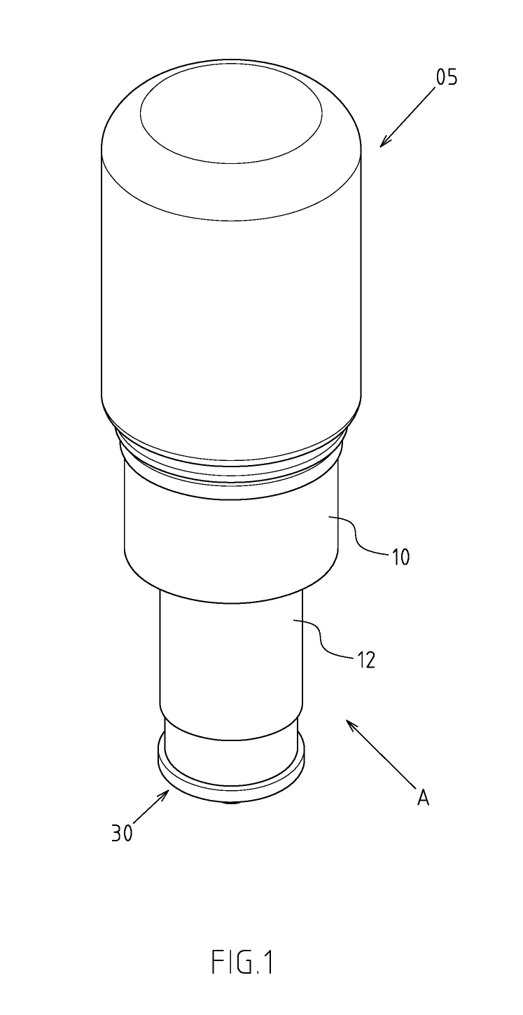

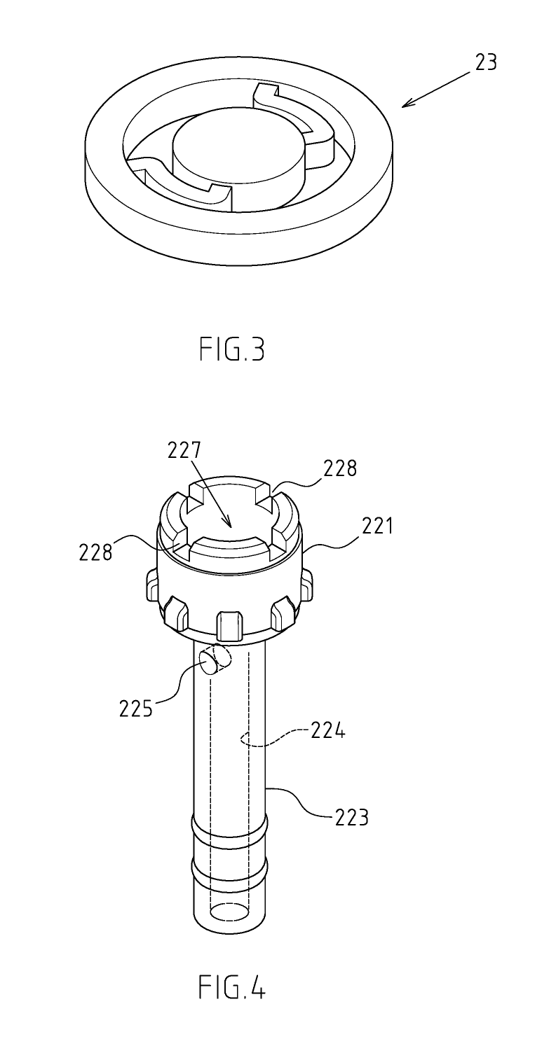

FIGS. 1 to 8 show the preferred embodiment of the downward liquid pump of the present invention, but this embodiment is for illustration only, the patent application is not limited to this structure. Said downward liquid pump A is fixed to an orifice 06 located at the lower end of an inverted container 05 to control the delivery state of a liquid 07 (emulsion, maple sugar, honey, condensed milk or beverage) in the inverted container 05.

Said downward liquid pump A comprises the following components: a circlet 10, its inner wall is provided with an internal thread 11 to lock an external thread 08 on the periphery of orifice 06 of the inverted container 05. A convex pipe part 12 is extended from the lower end of the circlet 10. A holding space 13 is formed in the circlet 10 and convex pipe part 12. A discharge actuating unit 20 is located in the holding space 13. The discharge actuating unit 20 comprises a pipe holder 21, a piston 22 and a check valve 23. There is an actuating cylinder 211 in the pipe holder 21. There is an inlet hole 212 in the top of the actuating cylinder 211, and there is a guide hole 213 in the bottom of the actuating cylinder 211. The check valve 23 is located in the lower part of inlet hole 212 in the top of the actuating cylinder 211. The piston 22 comprises a head end 221, a piston ring 222 and a shaft lever 223. The piston ring 222 is slidable and closed on the inner wall of the actuating cylinder 211. The shaft lever 223 can slide up and down through the guide hole 213 in the bottom of the actuating cylinder 211 and extend into the convex pipe part 12 located at the lower end of the circlet 10. A guide channel 224 is located axially in the shaft lever 223. The upper end of the guide channel 224 is connected to the actuating cylinder 211 via at least two radial through holes 225. There is a liquid stream clearance 226 between the periphery of the head end 221 and the inner wall of the actuating cylinder 211. The piston ring 222 of the piston 22 can be displaced up and down against the shaft lever 223, so as to close the connection between the radial through hole 225 and the actuating cylinder 211 optionally. A discharge end 30, located in the lower end of shaft lever 223 of the piston 22. The discharge end 30 is provided with a discharge hole 31 connected to the guide channel 224 of the shaft lever 223. An elastic restoring component 40 (which is but not limited to a helical spring), bracing between the discharge end 30 and the pipe holder 21 of the discharge actuating unit 20, so as to restore the discharge end 30 downward by elastic bracing normally. A housing 50 fitted over the upper periphery of pipe holder 21 of the discharge actuating unit 20, and the housing 50 is spaced from the upper periphery of the pipe holder 21. An air chamber 60 formed from the spacing between the housing 50 and the upper periphery of the pipe holder 21, and the upper end of the air chamber 60 is provided with an air pressure connecting passage 61 connected to the inside of the inverted container 05. At least two air inlets 70 located in the lower segment of the pipe holder 21. The air inlet 70 has an outer end 71 and an inner end 72. The outer end 71 is connected to the inner space of convex pipe part 12 at the lower end of the circlet 10. The inner end 72 is connected to the air chamber 60. The air inlet 70 leads the outside air in the air chamber 60.

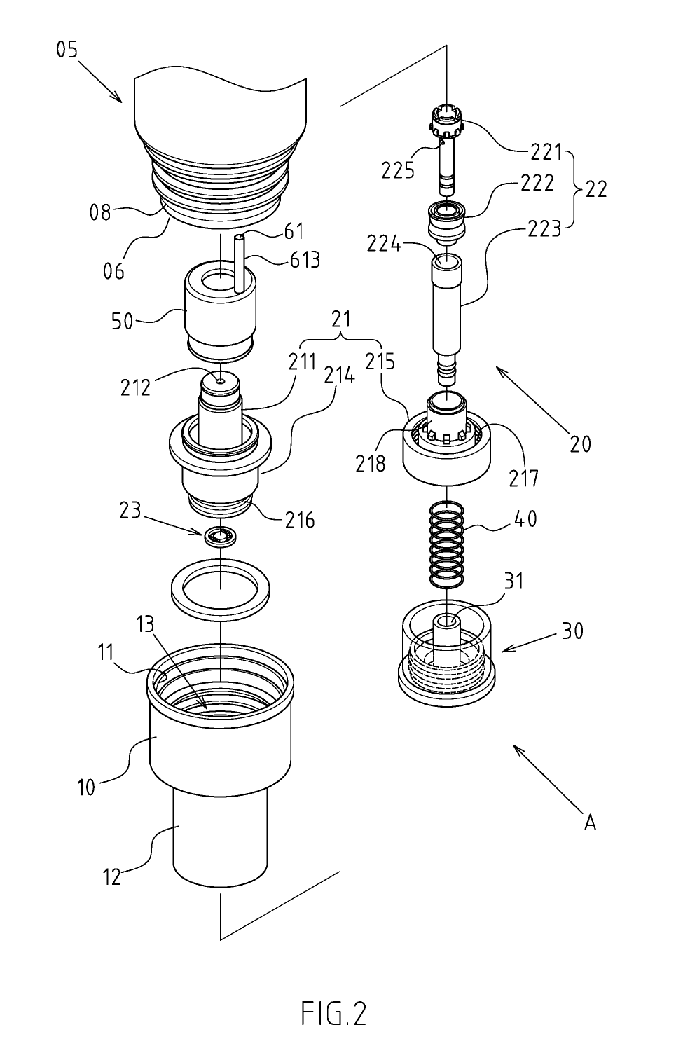

As shown in FIGS. 2 and 5, the lower segment of the pipe holder 21 comprises an upper holder 214 and a lower holder 215. The upper holder 214 and the lower holder 215 are provided with a circular flange 216 and a ring slot 217 matching each other, the annular clearance formed in the junction of the circular flange 216 and the ring slot 217 forms the air inlet 70. A limited pipe part 218 protrudes upward from the upper center of the lower holder 215, which is embedded in the lower inner wall of actuating cylinder 211 of the pipe holder 21, so that the guide hole 213 in the bottom of the actuating cylinder 211 is formed in the inner wall of the limited pipe part 218. In this case, the lower segment of the pipe holder 21 is formed of upper holder 214 and lower holder 215, forming the air inlet 70 and piston 22 retaining structure part.

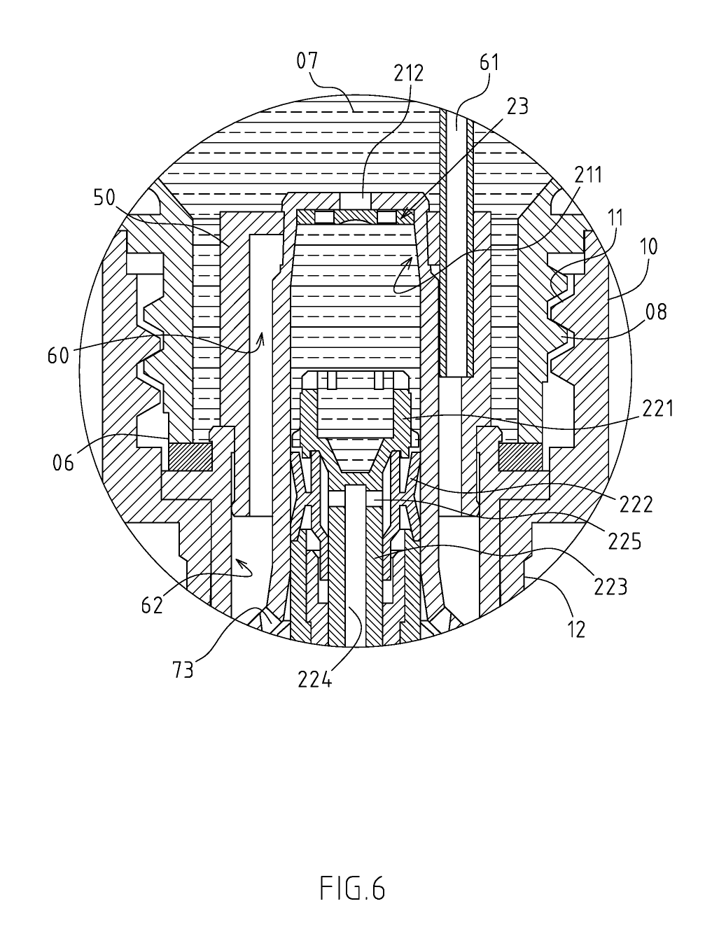

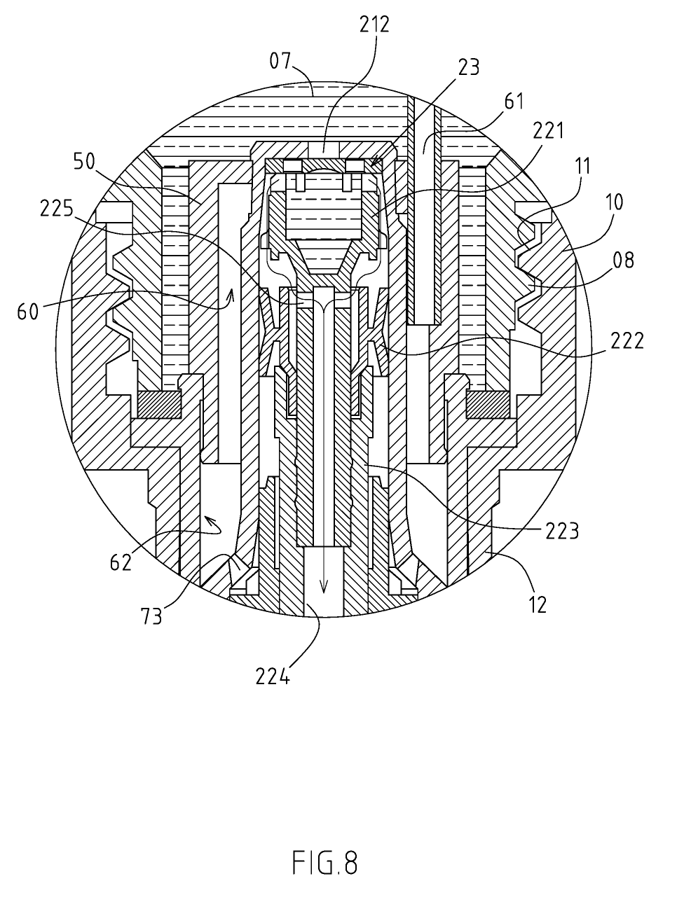

As shown in FIGS. 6 and 8, the head end 221 of the piston can be displaced up and down against the piston ring 222, and when the head end 221 shifts upward to the top of the actuating cylinder 211 (as shown in FIG. 8), the upper end of the piston ring 222 is disconnected from the head end 221, so that the liquid 07 above the head end 221 flows downward through the liquid stream clearance 226 into the radial through hole 225 and the guide channel 224. When the head end 221 shifts downward to the bottom of the actuating cylinder 211 (as shown in FIG. 6), the upper end of the piston ring 222 contacts the head end 221 tightly, so as to close the radial through hole 225.

As shown in FIG. 5, when the piston ring 222 of the piston shifts downward to the valley of the set travel, the height of lower end of the piston ring 222 (see H1) is lower than the height of lower end of the circlet 10 (see H2).

As shown in FIG. 5, an extended air chamber space 62 is extended from the lower end of the air chamber 60. The height of the bottommost end of the extended air chamber space 62 is lower than the height of the lower end of the piston ring 222 displaced downward to the valley of the set travel.

As shown in FIG. 5, the upper wall of pipe holder 21 of the discharge actuating unit 20 must be lower than the height of one circlet 10 above the circlet 10. According to the component configuration defined in previous two paragraphs, the height of the upper wall of pipe holder 21 of the discharge actuating unit 20 is reduced a lot. As shown in FIG. 5, the upper wall of pipe holder 21 of discharge actuating unit 20 is approximately level with the upper end of circlet 10, but actually it can be lower. Thus, the overall structure of the discharge actuating unit 20 hardly occupies the liquid holding space of the inverted container 05, the holding capacity of the inner space of the inverted container 05 is maximized.

As shown in FIG. 5, the air pressure connecting passage 61 in the upper end of the air chamber 60 is a vertical pipe 613. The upper end of the vertical pipe 613 protrudes upward to the upper wall of the inverted container 05, and the level of liquid 07 in the inverted container 05 is lower than the upper end of the vertical pipe 613. By the definition of this structure type, when the liquid 07 in the inverted container 05 is delivered, the air can be supplied to the internal upper space through vertical pipe 613 easily, so as to keep normal pressure in the inverted container 05, the liquid 07 can be discharged normally without vacuum suction.

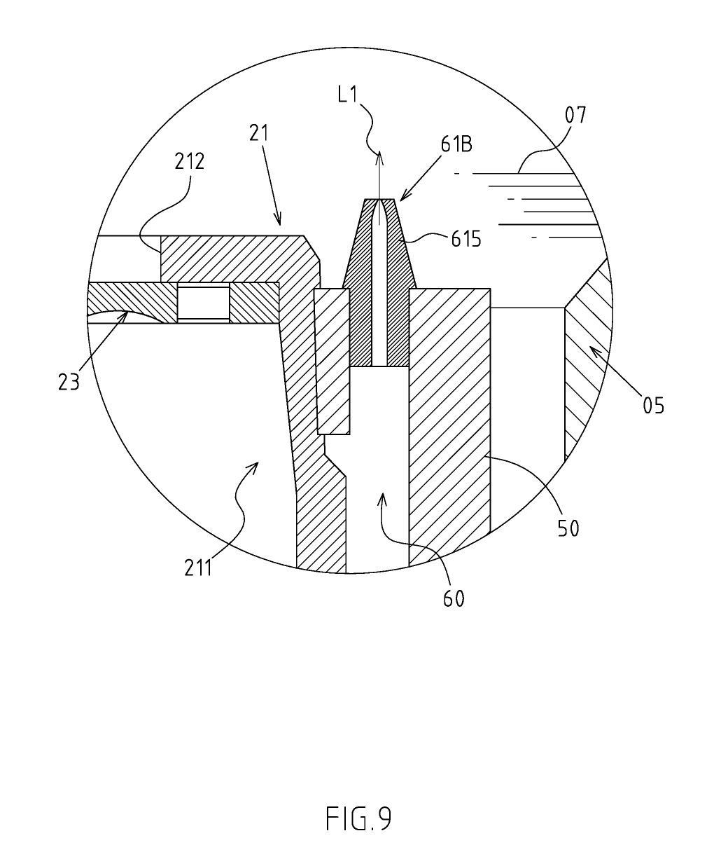

As shown in FIG. 9, in this case, the air pressure connecting passage 61B in the upper end of the air chamber 60 is a non-return valve 615. The non-return valve 615 only allows the air of the air chamber 60 to enter the inverted container 05 (see Arrow L1), and prevents the liquid 07 in the inverted container 05 from entering the air chamber 60.

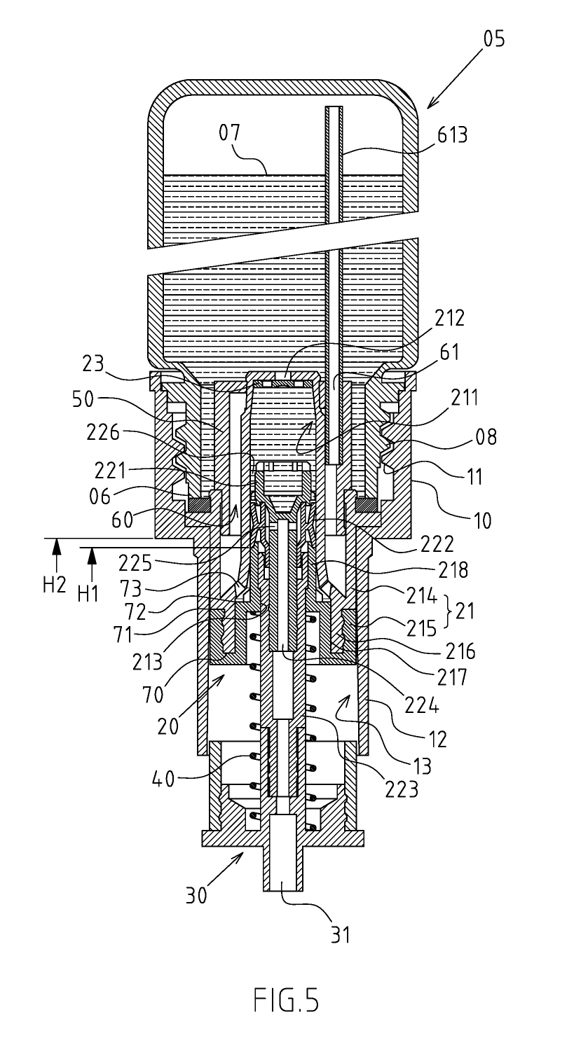

As shown in FIG. 4, a slot 227 is formed in the head end 221 of the piston, and there are plural notches 228 around the top of the slot 227. In this case, as the liquid 07 is delivered to the slot 227, the head end 221 of the piston generates hydraulic delivery during up-and-down displacement, the actuation of the head end 221 of the piston is guided.

As shown in FIG. 5, the inner end 72 of the air inlet 70 is connected to the air chamber 60 via plural air holes 73.

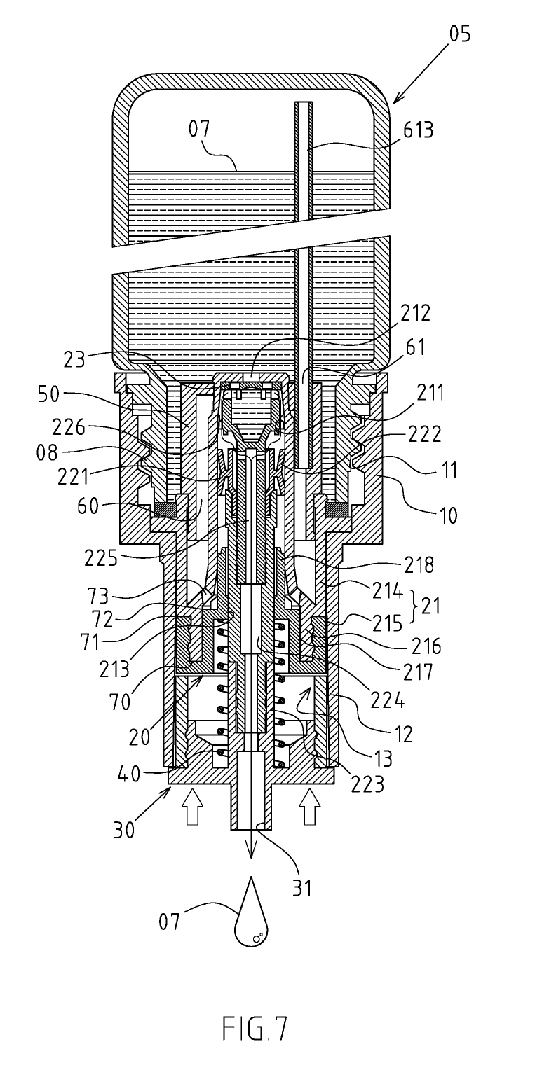

According to the aforesaid structural composition and technical characteristics, the in-service use of the downward liquid pump A disclosed by the present invention is shown in FIGS. 5 and 6. The elastic restoring component 40 braces the discharge end 30 elastically and downward. In this state, the head end 221 of the piston shifts downward to the bottom of actuating cylinder 211, and the upper end of piston ring 222 contacts the head end 221 tightly to close the radial through hole 225. A part of liquid 07 in the inverted container 05 is delivered downward to the actuating cylinder 211 through the inlet hole 212 and check valve 23. As shown in FIGS. 7 and 8, to extrude the liquid 07, the discharge end 30 is pushed upward, the shaft lever 223 is pushed up synchronously and the head end 221 is displaced upward to the top of actuating cylinder 211, and the upper end of piston ring 222 is disconnected from the head end 221, so that the liquid 07 above the head end 221 flows downward through the liquid stream clearance 226 into the radial through hole 225 and the guide channel 224, and then discharged downward through the discharge hole 31 in the discharge end 30. In terms of air pressure, based on said air chamber 60, air pressure connecting passage 61 and air inlet 70, the upper end of the air chamber 60 is connected to the inside of inverted container 05 through the air pressure connecting passage 61, and the outer end 71 of air inlet 70 is connected to the inner space of convex pipe part 12 in the lower end of circlet 10, and the inner end 72 is connected to the air chamber 60 via the air hole 73. Therefore, the air inlet 70 leads the outside air in the air chamber 60 and inverted container 05, so that air pressure in the inverted container 05 is kept in normal condition, there will not be vacuum suction as the liquid 07 is discharged.

In addition, when said downward liquid pump A of the present invention is fixed to the orifice 06 in the lower end of the inverted container 05, it can be mounted on a handling frame body (note: not drawn), said handling frame structure can be provided with buttons, press plate or cup backup plate for user operation, so as to drive the discharge end 30 to push upward indirectly, the convenience is better.

In addition, the fixation of said downward liquid pump A of the present invention to the orifice 06 in the lower end of the inverted container 05 is not completely limited to the configuration state of normal axis, it can be the configuration state with a tilt angle. This kind of variation does not influence the effect to be attained by the present invention.

We claim:

1. A downward liquid pump, said downward liquid pump A is to be fixed to an orifice in the lower end of an inverted container, to control the delivery state of liquid in the inverted container; the downward liquid pump A comprises:
a circlet, its inner wall is provided with an internal thread to lock an external thread around the orifice of the inverted container, and a convex pipe part is extended from the lower end of the circlet, a holding space is formed in the circlet and convex pipe part;
a discharge actuating unit located in the holding space. The discharge actuating unit comprises a pipe holder, a piston and a check valve; there is an actuating cylinder in the pipe holder; there is an inlet hole in the top of the actuating cylinder, and there is a guide hole in the bottom of the actuating cylinder; the check valve is located under the inlet hole in the top of the actuating cylinder; the piston comprises a head end, a piston ring and a shaft lever; the piston ring is slidable and closed on the inner wall of the actuating cylinder; the shaft lever can slide up and down through the guide hole in the bottom of the actuating cylinder and protruding in the convex pipe part at the lower end of the circlet; a guide channel is located axially in the shaft lever, and the upper end of the guide channel is connected to the actuating cylinder via at least two radial through holes; there is a liquid stream clearance between the periphery of the head end and the inner wall of the actuating cylinder; the piston ring of the piston shifts up and down against the shaft lever, so as to close the connection between the radial through hole and the actuating cylinder optionally;
a discharge end located in the lower end of shaft lever of the piston, the discharge end is provided with a discharge hole connected to the guide channel in the shaft lever;
an elastic restoring component bracing between the discharge end and the pipe holder of the discharge actuating unit, to restore the discharge end downward elastically and normally;
a housing fitted over the upper periphery of pipe holder of the discharge actuating unit, and the housing is spaced from the upper periphery of the pipe holder;
an air chamber is formed from the spacing between the housing and the upper periphery of the pipe holder, and the upper end of the air chamber is provided with an air pressure connecting passage connected to the inside of the inverted container; at least two air inlets located in the lower segment of the pipe holder; the air inlet has an outer end and an inner end; the outer end is connected to the inner space of convex pipe part at the lower end of the circlet; the inner end is connected to the air chamber; the air inlet leads the outside air in the air chamber.

2. The device defined in claim 1, wherein the lower segment of the pipe holder comprises an upper holder and a lower holder; the upper holder and the lower holder are provided with a circular flange and a ring slot matching each other, so that the annular clearance formed in the junction of the circular flange and the ring slot forms the air inlet; a limited pipe part protrudes upward from the upper center of the lower holder, embedded in the lower inner wall of the actuating cylinder of the pipe holder, so that the guide hole in the bottom of the actuating cylinder forms in the inner wall of the limited pipe part.

3. The device defined in claim 2, wherein the head end of the piston can shift up and down against the piston ring, and the upper end of the piston ring is disconnected from the head end when the head end shifts upward to the top of the actuating cylinder, so that the liquid above the head end flows downward through the liquid stream clearance into the radial through hole and the guide channel; when the head end shifts downward to the bottom of the actuating cylinder, the upper end of the piston ring contacts the head end tightly, so as to close the radial through hole.

4. The device defined in claim 3, wherein when the piston ring of the piston shifts downward to the valley of the set travel, the lower end of the piston ring is lower than the lower end of the circlet.

5. The device defined in claim 4, wherein an extended air chamber space is extended downward from the lower end of the air chamber; the bottommost end of the extended air chamber space is lower than the lower end of the piston ring displaced downward to the valley of the set travel.

6. The device defined in claim 5, wherein the upper wall of pipe holder of the discharge actuating unit must be lower than the height equivalent to one circlet above the circlet.

7. The device defined in claim 6, wherein the air pressure connecting passage in the upper end of the air chamber is a vertical pipe; the upper end of the vertical pipe protrudes upward to somewhere about the upper wall of the inverted container, and the level of the liquid in the inverted container is lower than the upper end of the vertical pipe.

8. The device defined in claim 6, wherein the air pressure connecting passage in the upper end of the air chamber is a non-return valve; the non-return valve only allows the air of the air chamber to enter the inverted container, and prevents the liquid in the inverted container from entering the air chamber.

9. The device defined in claim 7, wherein a slot is formed in the head end of the piston, and there are plural notches around the top of the slot.

10. The device defined in claim 8, wherein a slot is formed in the head end of the piston, and there are plural notches around the top of the slot.

11. The device defined in claim 7, wherein the inner end of the air inlet is connected to the air chamber via plural air holes.

12. The device defined in claim 8, wherein the inner end of the air inlet is connected to the air chamber via plural air holes.
